(19) United States
(12) Patent Application Publication
(10) Pub. No.: US 2022/0198888 A1
(43) Pub. Date: Jun. 23, 2022

(54) METHOD AND APPARATUS FOR COMMUNICATING BETWEEN INTER-FLOOR NEIGHBORS TO PREVENT DISPUTE OVER NOISE BETWEEN FLOORS

(71) Applicants: Sungpil CHUN, Seongnam-si (KR); Yongseob Lim, Daegu (KR); Jungpyeong Hwang, Daegu (KR); Geunhui Shin, Daegu (KR); Seonhwa Kim, Daegu (KR); Dongju Choi, Daegu (KR)

(72) Inventors: Sungpil CHUN, Seongnam-si (KR); Yongseob Lim, Daegu (KR); Jungpyeong Hwang, Daegu (KR); Geunhui Shin, Daegu (KR); Seonhwa Kim, Daegu (KR); Dongju Choi, Daegu (KR)

(73) Assignees: Sungpil Chun, Seongnam-si (KR); Yongseob Lim, Daegu (KR)

(21) Appl. No.: 17/557,714

(22) Filed: Dec. 21, 2021

(30) Foreign Application Priority Data
Dec. 21, 2020 (KR) 10-2020-0179146
May 10, 2021 (KR) 10-2021-0059830

(51) Int. Cl. G08B 5/22; G08B 21/18; G06F 3/04817; G06F 3/0482

(52) U.S. Cl. CPC G08B 5/225; G06F 3/0482; G06F 3/04817; G08B 21/18

(57) ABSTRACT

The present invention provides a method and apparatus for communicating with neighbors between floors for preventing and amicably solving disputes related to inconveniences such as the floor noise.

An inter-floor neighbor communication method according to an embodiment comprises (i) storing, by a server, identification information of users of terminal devices for inter-floor neighbor relationship of the users; (ii) receiving, from a first terminal device of a first user, the identification information of a second user who is a neighbor of the first user and with whom is selected for communication by the first user; (iii) communicatively connecting the first and the second terminal devices based on the identification information; and (iv) transmitting, by the server, current status information of the first user on inconvenience to the second terminal device of the second user.

### CROSS-REFERENCE TO THE RELATED APPLICATION

This application claims priority from Korean Patent Applications No. 10-2020-0179146, filed on Dec. 21, 2020, and No. 10-2021-0059830, filed on May 10, 2021, in the Korean Intellectual Property Office, the disclosure of which is incorporated herein in its entirety by reference.

### BACKGROUND

### 1. Field

The present invention relates to an apparatus and method for communicating with neighbors with understanding and consideration in order to smoothly resolve disputes between neighbors due to inconveniences such as noise between floors in an apartment residence.

### 2. Description of the Related Art

According to the K-APT of the Ministry of Land, Infrastructure and Transport, the proportion of apartment residences has increased every year, reaching about 77% in 2019. As the time spent at home increases due to the corona pandemic, conflicts and mental stress caused by noise between floors have become a big social problem in recent years. Floor noise complaints received at the Floor Noise Management Center of the Ministry of Environment also increased significantly.

Downstairs Residents complain of physical and mental pain due to the noise from the upper floors, while those on the upper floors complain of psychological anxiety and psychological stress caused by frequent complaints from downstairs. Incidents that lead to murder between inter-floor neighbors often occur. Discords may also arise between family members living upstairs. In addition, it can cause financial loss and deterioration of the living environment due to moving out because it cannot withstand the physical and mental stress caused by the floor noise.

According to a survey conducted in 2013, 9 out of 10 Koreans answered that they were stressed due to the floor noise, and half of them said they had an experience of arguing with neighbors due to the floor noise. It was surveyed that 22% of the respondents purchased products to prevent the floor noise even if they did not argue with neighbors. Not only apartments, but also multi-unit residences were found to have experienced stress due to the floor noise.

The types of the floor noise include children running (36%), home appliances such as TVs and washing machines (18%), adults footsteps (16%), musical instruments such as pianos (9%), and door opening and closing noises (9%) and sensitivity of the neighbors (5%). In addition to the floor noise, it is not uncommon for disputes over inconveniences such as smoking, food smell, dog barking, and air conditioner outdoor unit to lead to lawsuits or violent crimes.

Technical, institutional, and legal measures have been proposed to solve these serious social problems. As the technical measure, the floor thickness is being increased or a noise shielding material is being inserted between the floors. However, since it results in increase in the construction cost of apartment residence, it cannot be widely adopted and can be applied only to new apartment residence.

Alternatively, there is a system that alerts the resident who caused the noise when the noise level exceeds a threshold. This method has the effect of alarming the resident causing the noise as to how much noise is transmitted to his/her neighbors. However, there is a disadvantage in that the noise alarm is triggered and notified even if his/her neighbors are not bothered by the noise or want to be considerate of the resident who has caused the noise. In addition, there are disadvantages such as the need to install a microphone or speaker in the neighbor residence, the installation cost is high, and it is difficult to distinguish between the false noise transmitted through various routes and the actual floor noise.

The Floor Noise Management Center is being operated by the government to resolve conflicts through mediation. Lack of staffs and authority for law enforcement reduce effectiveness.

The government introduced the administrative measure to measure the floor impact noise volume for newly constructed apartment residence after the construction is complete to address the floor noise issue. However, there is a problem in that this cannot be applied to existing apartments.

In the end, it has no choice but to solve the problem with the efforts of the tenants themselves. Since the construction method of newly built apartment residence in Korea is a wall-type structure that is vulnerable to the floor noise, there is an urgent need for technology that can prevent and effectively resolve disputes over the floor noise between neighbors.

### SUMMARY

What is needed to prevent and resolve the floor noise disputes are understanding, consideration, and smooth communication between neighbors. To this end, we aim to provide a communication method and apparatus between neighbors for gentle communication with mutual understanding and consideration for neighbors.

According to an embodiment of this invention, a method of communicating among neighbors between floors includes the steps of: storing, by a server, identification information of users of terminal devices for inter-floor neighbor relationship of the users; receiving, from a first terminal device of a first user, the identification information of a second user who is a neighbor of the first user and with whom is selected or to be selected for communication by the first user; communicatively connecting the first and the second terminal devices based on the identification information; and transmitting, by the server, current status information of the first user on inconvenience to the second terminal device of the second user. Here, the inconvenience is to be caused by the second user.

The communication method may further include the step of storing, by the server, each neighbor information related to living spaces of at least one users of the terminal devices. Here, the neighbor information is one that is stored either prior to or apart from communication instances between the users and the neighbor information is exclusively shared among the terminal devices of the users who are in the inter-floor neighbor relationship. The communication method may further include the step of sending a notification to the second terminal device if the current status information is changed.

The inter-floor neighbor relationship may be set by the server based on the identification information of the users. The identification information of a user is provided either upon input by his or her own or upon scanning an identification code by his or her neighbor user. The identification code such as a QR code embeds the identification information in a manner that any personal information is not exposed. The identification code may include at least one of an URL link for installation of an application software (hereinafter, “app”) for the terminal device, an identification information of the user, and a residence information of the user. More specifically, in order to set the inter-floor neighbor relationship, the server can obtain residence information of users of the terminal devices, and then establish the neighbor relationship among the resident users upstairs, downstair, or living door-to-door based on the residence information. In order for a resident user to select the inter-floor neighbor to communicate with, at least one inter-floor neighbor may be selected from among the inter-floor neighbors residing upstairs, downstairs, or living next door side by side.

One or more of predetermined status phrases or images may be selected by the first resident user downstairs as the current status information. Also, the current state information may be a plurality of words or a second sentence converted into a more refined expression from a first sentence composed of a plurality of words having been received so that the second resident user upstairs may not be offended. Alternatively, the current status information may be a sentence or phrases composed of one or more of expressions which indicate the inconvenience caused, a time period of the inconvenience, or a type of suffering endured by the first resident user. Alternatively, the current status information is a signal determined based on either (i) at least one sensing data collected from a camera, a microphone, an objection detection sensor or various IoT sensors, or (ii) the neighbor information. In this case, even without a manual input by the first user, the current status information of the first user will automatically be generated and transmitted to the second resident user upstairs. The neighbor information may be at least one of human, temporal, and object information related to the corresponding living space. The personal information is the members of the resident or classification of resident members, i.e., a person vulnerable to the noise, a person or pet likely to generate noise. The temporal information is a time period scheduled to generate noise upstairs or a time period during which calmness is requested by a downstairs resident. The object information is an effort to reduce the noise or a product preventing the noise such as a cushioning mat on the floor.

In accordance with another embodiment, a method for communicating between floor neighbors comprises (i) the step of receiving, by a first terminal device of a first user, identification information of a second user who is a neighbor of the first user and with whom is selected or to be selected for communication by the first user; (ii) the step of establishing, by a server, a communication connection with the first terminal device and a second terminal device of the second user; (iii) the step of transmitting, by a server, a current status information of the first user on inconvenience to be caused by the second user and a neighbor information on living space of the first user to a second terminal device of the second user; and (iv) the step of notifying the second user of the changed current status information when the current status information is changed. In this embodiment, if the first user is a downstairs resident, the current status information may be a first feedback information on the inconvenience such as noise between floors caused by the second user who is a upstairs resident, and if the first user is a upstairs resident, the current status information may be a second feedback information by the upstairs resident to the first feedback information. The neighbor information may be at least one of human, temporal, and object information related to the corresponding living space. The personal information is the members of the resident or classification of resident members, i.e., a person vulnerable to the noise, a person or pet likely to generate noise. The temporal information is a time period scheduled to generate noise upstairs or a time period during which calmness is requested by a downstairs resident. The object information is an effort to reduce the noise or a product preventing the noise such as a cushioning mat on the floor. In accordance with another embodiment, an apparatus of communicating among neighbors between floors comprises (i) a communication interface connected in a network to terminal devices of resident users; (ii) a memory storing instructions and identification information of the resident users executable by a processor; and (iii) the processor, through the computer-executable command, configured to execute instructions. The instructions can include (i) the step of storing identification information of users of terminal devices for inter-floor neighbor relationship of the resident users; (ii) receiving the identification information of a second resident user who is a neighbor of the first user and with whom is selected or to be selected for communication by the first resident user; (iii) communicatively connecting the first and the second terminal devices based on the identification information; and (iv) transmitting current status information of the first resident user on inconvenience to the second terminal device of the second user. Here, the inconvenience is caused by the second user.

In this embodiment, if the first user is a downstairs resident, the current status information may be a first feedback information on the inconvenience such as noise between floors caused by the second user who is a upstairs resident, and if the first user is a upstairs resident, the current status information may be a second feedback information by the upstairs resident to the first feedback information. The neighbor information may be at least one of human, temporal, and object information related to the corresponding living space. The personal information is the members of the resident or classification of resident members, i.e., a person vulnerable to the noise, a person or pet likely to generate noise. The temporal information is a time period scheduled to generate noise upstairs or a time period during which calmness is requested by a downstairs resident. The object information is an effort to reduce the noise or a product preventing the noise such as a cushioning mat on the floor. One or more of predetermined status phrases or images may be selected by the first resident user downstairs as the current status information. Also, the current state information may be a plurality of words, or a second sentence converted into a more refined expression from a first sentence composed of a plurality of words having been received so that the second resident user upstairs may not be offended. Alternatively, the current status information may be a sentence or phrases composed of one or more of expressions which indicate the inconvenience caused, a time period of the inconvenience, or a type of suffering endured by the first resident user. Alternatively, the current status information is a signal determined based on either (i) at least one sensing data collected from a camera, a microphone, an objection detection sensor or various IoT sensors, or (ii) the neighbor information. In this case, even without a manual input by the first user, the current status information of the first user will automatically be generated and transmitted to the second resident user upstairs. The instructions may further include the step of storing each neighbor information related to living spaces of at least one users of the terminal devices. Here, the neighbor information is one that is stored either prior to or apart from communication instances between the users and the neighbor information is exclusively shared among the terminal devices of the users who are in the inter-floor neighbor relationship. The instructions may further include the step of sending a notification to the second terminal device if the current status information is changed.

In this embodiment, the inter-floor neighbor relationship may be set by the processor based on the identification information of the users. The identification information of a user is provided either upon input by his or her own or upon scanning an identification code by his or her neighbor user. The identification code such as a QR code embeds the identification information in a manner that any personal information is not exposed. The identification code may include at least one of an URL link for installation of an application software (hereinafter, “app”) for the terminal device, an identification information of the user, and a residence information of the user. More specifically, in order to set the inter-floor neighbor relationship, the processor can obtain residence information of users of the terminal devices, and then establish the neighbor relationship among the resident users upstairs, downstair, or living door-to-door based on the residence information. In order for a resident user to select the inter-floor neighbor to communicate with, at least one inter-floor neighbor may be selected from among the inter-floor neighbors residing upstairs, downstairs, or living next door side by side.

According to another embodiment, a method of communicating between a first and a second resident users who are in an inter-floor neighboring relationship comprises (i) the step of providing a first feedback information by the first resident user living downstairs on an inconvenience occurred in the space of the second resident user living upstairs to a terminal device of the second resident user. Here, the first feedback information may be a purified expression selected by the first resident user or converted into a more polite or purified one from an original expression spoken by the first resident user so that the second resident user may not be offended. In this embodiment, the purified expression is made up of a plurality of emoji combinations, and each emoji can represent the cause of the inconvenience, information about the time of the occurrence, and a type of suffering endured. The inconvenience may be noise between floors, and the purified expression may be a sentence using words including at least two information on the source of noise, the time of the noise generation, and the suffering. This method may comprise further the step of providing second feedback information by the second resident user living upstairs on the first feedback to the terminal device of the first resident user. The second feedback information may be an expression connoting a meaning selected from ‘apology’ and ‘clearing misunderstandings’. The first feedback information may be a sentence recommended on the terminal device of the first resident user by using a combination of the selected purified expressions by the first resident user.

According to yet another embodiment, a method of communicating between a first resident and a second resident who are in an inter-floor neighboring relationship comprises the step of providing a first feedback information by the first resident user living downstairs on the inconvenience occurred in the space of the second resident living upstairs to a terminal device of the second resident user. Here, the first feedback information may be a sentence converted into an expression of a third party's point of view from the original expression spoken by the first resident user.

According to yet another embodiment, a method of communicating between an inter-floor neighbors comprises (i) the step of inputting the residence information of the first resident user and an information on an application software to the terminal of the second resident user who is in an inter-floor neighbor relationship with the first resident user; (ii) the step of installing the application software in the terminal of the second resident user based on the installation information by a processor of the terminal device of the second resident user; and (iii) the step of storing the first and second resident users in the terminal devices of the first and second resident users as an inter-floor neighbors based on the residence information of the second resident.

According to yet another embodiment, a method of communicating with neighbors between floors comprises (i) the step of communicatively connecting terminal devices of first and second resident users in an inter-floor neighboring relationship; and (ii) the step of providing rules agreed by the inter-floor neighbors in connection with an occurrence of inconvenience to the terminal devices of first and second resident users. In this embodiment, the step of the providing the rules comprises (i) the step of providing the rules to any one terminal device; (ii) the step of providing a feedback on the rules to the other terminal device; and (iii) the step of providing the rules finally agreed upon by the first and second resident users to the terminal devices of the first and second resident users, respectively.

According to yet another embodiment, an apparatus of communicating between inter-floor neighbors comprises (i) a communication interface; (ii) an I/O interface for an user input or output; (iii) a memory storing instructions executable by a processor; and (iv) the processor, through the computer-executable command, configured to execute instructions. The instructions may include (i) the step of receiving a command of a first resident for selecting his/her neighbor to communicate with based on an information on a neighboring relationship between users of an application software; and (ii) the step of outputting a current status information on the inconvenience caused by the neighbor to the first resident.

According to yet another embodiment, a terminal device for communication between a first resident and a second resident users who are in an inter-floor neighbor relationship comprises (i) communication interface; (ii) an input/output interface for user input/output; (iii) a memory storing instructions executable by the processor; and (iv) a processor for providing the first feedback information of the first resident user about the inconvenience caused in the space of the second resident to the terminal of the second resident user by executing the computer-executable instruction, In this embodiment, the first feedback information is composed of one of a sentence combining words selected by a first resident user or a sentence converted from an original sentence input by the first resident user into an purified expression from a virtual moderator's point of view.

According to the present invention, by automatically establishing a communication channel based on inter-floor neighbor relationship information in relation to inconveniences such as the floor noise, requests can be exchanged easily and quickly without face to face confrontation. An amicable resolution can be achieved by limiting exchanged messages to kind, polite and/or purified expressions and by limiting shared information to information that helps to understand and consider neighbors in relation to the floor noise.

In addition, since the status of the lower floors regarding the floor noise can be recognized by residents on the upper floor in real time, the residents on the upper floor can live a life comfortably without concern about dispute over the floor noise, or they can voluntarily refrain from action generating the noise if receiving immediate feedback on whether their actions caused the floor noise.

Also, the upstairs resident who received a request for containing the noise from his/her neighbors can eliminate misunderstanding of his/her downstairs neighbor by sending the neighbor a message that the noise was not from his/her home.

Disputes can be minimized by sharing consideration rule agreed by inter-floor neighbors or schedule of noise or calmness with neighbors in advance.

One can express one's gratitude or apology to one's neighbors with gifts, and one can cultivate mutual consideration by purchasing anti-noise products for one's neighbors.

### BRIEF DESCRIPTION OF THE DRAWINGS

FIG. 1 is a view showing the inter-floor neighbor relationship among residence of an apartment house.

FIG. 2 is a diagram schematically illustrating a system environment in which a method for communicating between neighbors according to an embodiment of the present invention is implemented.

FIG. 3 is a flowchart illustrating a pairing method for establishing an inter-floor neighbor relationship according to an embodiment of the present invention.

FIG. 4 is a diagram illustrating the identification code such as QR code and information embedded therein for establishing an inter-floor neighbor relationship and pairing terminal devices of inter-floor neighbors according to an embodiment of the present invention.

FIG. 5 is a database of an identification information of app users stored in an apparatus according to an embodiment of the present invention.

FIG. 6 is a flowchart showing the sequence of the communication method according to an embodiment of the present invention in an inter-floor neighbor communication app.

FIG. 7 is a main screen of the inter-floor neighbor communication app according to the embodiment.

FIG. 8 is a current status setting screen of the inter-floor communication neighbor app according to the embodiment.

FIG. 9 is a screen showing various settings in the inter-floor neighbor communication app according to the embodiment.

FIG. 10 is a screen for displaying a notification reminding a current status setting in the inter-floor neighbor communication app according to the embodiment.

FIG. 11 is a screen for displaying a current status change notification in the inter-floor neighbor communication app according to the embodiment.

FIG. 12 is a screen for setting a human information as one of a neighbor information, i.e., family member in the inter-floor neighbor communication app according to the embodiment.

FIG. 13 is a screen for setting consideration rules in the inter-floor neighbor communication app according to the embodiment.

FIG. 14 is showing a method of selecting an inter-floor neighbor for communication in the inter-floor neighbor communication app according to the embodiment.

FIG. 15A to 15D are screens illustrating how to generate a suggestion message in the inter-floor neighbor communication app according to the embodiment.

FIG. 16 is a screen showing a method of delivering the suggestion message through a virtual moderator in the inter-floor neighbor communication app according to another embodiment.

FIG. 17 is a screen for notifying the receipt of the message sent by a neighbor in the inter-floor neighbor communication app according to the embodiment.

FIG. 18 is a screen showing a method of generating a feedback message by a neighbor who has received a message from his/her neighbor in the inter-floor neighbor communication app according to the embodiment.

FIG. 19 is a screen showing an example of generating an apology message as the feedback to the message of FIG. 18.

FIG. 20 is a screen showing another example of generating an apology message as the feedback to the message of FIG. 18.

FIG. 21 is a screen showing yet another example of generating an apology message as the feedback to the message of FIG. 18.

FIG. 22 is a screen showing a suggestion message and a feedback message exchanged between the inter-floor neighbors according to the embodiment.

FIG. 23 is a screen showing a method of generating a message for eliminating misunderstandings as feedback to the suggested message in the inter-floor neighbor communication app according to the embodiment.

FIG. 24 is a screen showing a method of generating a suggestion message in an inter-floor neighbor communication app according to yet another embodiment.

FIG. 25 is a diagram showing examples in which a suggestion message is converted into purified or more polite expressions in an inter-floor neighbor communication app.

### DETAILED DESCRIPTION

The contents described below are only for embodiments of the present invention, but the present invention is not limited thereto. The terms used in this specification are only used to describe specific embodiments and are not intended to limit the present invention. For example, although the embodiment of the present invention is described by taking the noise between floors as an example, it can be applied to other inconveniences such as the smell of garbage, smoking, barking pets or construction noise.

Hereinafter, embodiments of the present invention will be described in detail with reference to the accompanying drawings.

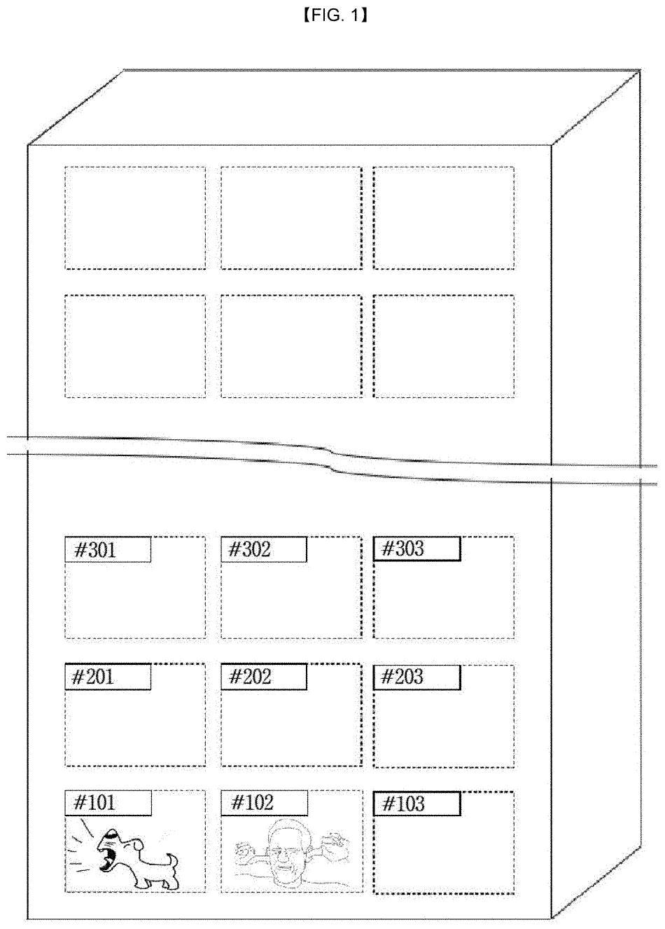

FIG. 1 shows the inter-floor neighbor relationship among residence of an apartment house. Around the Residence #202, there are Residence #201 in side, #102 toward below, #302 and #402 toward the top. The floor noise felt in Residence #102 is not necessarily generated by Residence #202. In some cases, the noise caused in Residence #302 or #402 may be passed to Residence #102. As such, there may be mistaken for a noise source between inter-floor neighbors. The noise source can be in next door or downstairs depending on types of floor noise, i.e., dog barking.

Accordingly, a method or an apparatus according to the embodiments may be configured for a resident to select his/her inter-floor neighbor for communication.

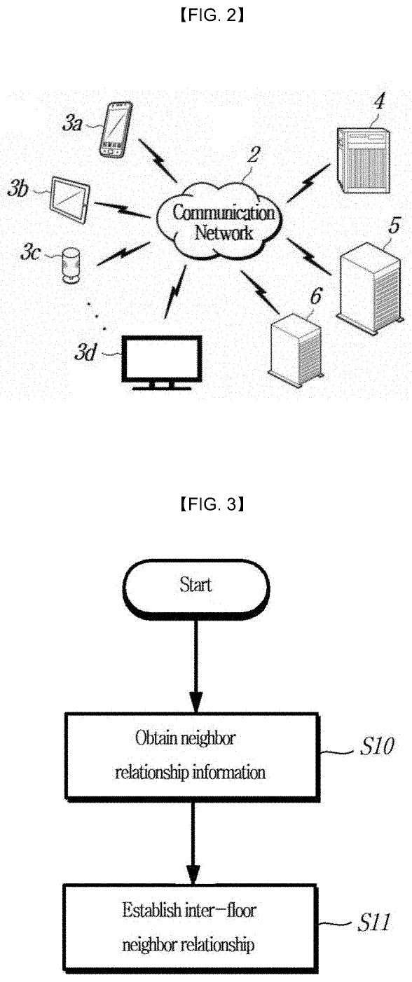

A system environment in which a communication method between neighbors according to an embodiment of the present invention can be implemented will be described with reference to FIG. 2. The system environment includes a plurality of user terminals 3a-3d, a communication network 2, a messenger service server 4, an AI agent server 5 and an external service server 6. According to the embodiment, each of the plurality of user terminals may be a user electronic device having a wired or wireless communication function. The user terminal may be an intercom, a smart phone, a tablet PC, a smart wall pad, a voice recognition AI speaker, a laptop, a smart TV, an indoor life assistant fixed or mobile robot, and the like.

According to the embodiment, each of the user terminal 3a-3d establishes a chat session with one or a plurality of other user terminals 3a-3d through the communication network 2 and the messenger service server 4. Through the established chat session, real-time information may be exchanged among one or more other user terminals 3a-3d in manners of voice and/or text message.

According to the embodiment, each of the user terminals 3a-3d may communicate with the AI agent server 5 through the communication network 2, that is, transmit/receive necessary information. According to an embodiment of the present invention, each of the user terminals 3a-3d may communicate with the external service server 6 through the communication network 2, i.e., transmit/receive necessary information. According to an embodiment of the present invention, each of the user terminals 3a-3d may receive a user input in the form of voice, text and/or touch, and provide to the user or other user, i.e., neighbor of the user to be selected for communication in order to confirm the result of converting the above user input.

According to an embodiment of the present invention, each of the user terminals 3a-3d displays the result of converting the user input in a visual, auditory and/or tactile form (e.g., including, but is not limited to, voice, sound, text, video, image, emoticon, animation, notification, motion, haptic feedback, and the like).

The AI agent server 5 receives a user input in the form of voice, text and/or touch from the user terminal 3a-3d through the communication network 2. The AI agent server 5 may determine the user's intention by processing the received user input based on the prepared knowledge model or AI models. Then, a refined and more polite expression corresponding to the user's intention may be generated and transmitted to the user terminals 3a-3d.

According to an embodiment of the present invention, depending on the type of user input received on the user terminals 3a-3d (e.g., whether it is a voice or a text message), a purified output of the same type as the user input on the AI agent server 5 can be generated. For example, a voice output may be generated when a voice input is given, and as such a text output can be generated when a text input is given. Alternatively, regardless of the form of user input, output in the form of voice and/or text message may be generated.

Hereinafter, embodiments of the present invention will be described using a mobile app installed on a smart phone as an example. The protection scope of the present invention should not be construed as being limited thereto. The inter-floor neighbor communication app may be installed on the terminal devices of each resident user.

For the downstairs resident to communicate with the upstairs resident through the app, the app must be installed on both terminal devices. After that, it is necessary to establish the inter-floor neighbor relationship. Throughout the specification, it is referred to as inter-floor neighbor pairing.

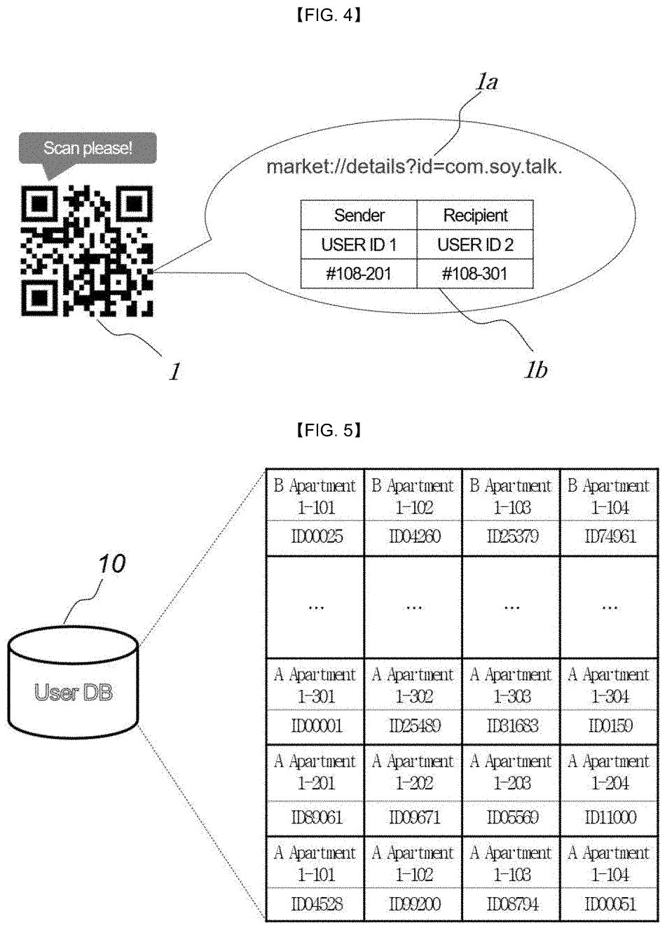

FIG. 3 is a flowchart illustrating a pairing method for establishing an inter-floor neighbor relationship according to an embodiment. In S10, neighbor relationship information is acquired. In S11, an inter-floor neighbor relationship is set based on this information. Such inter-floor neighbor pairing may be performed in various ways.

For example, as shown in FIG. 4, a downstairs resident who has already installed the app may put an identification code in a gratitude gift while sending the gift to a upstairs resident. As an example of the identification code, the QR code 1 may include installation information 1a of the app and neighbor relationship information 1b. Upstairs resident who received the gift can scan the QR code 1 to automatically be linked to the app's installation page and install it conveniently. Based on the neighbor relationship information 1b, the neighbor relationship between the inter-floor neighbors may be set. Neighbor relationship information 1b may be the sender and the recipient's Residence number or addresses. In this case, the user identification information may be stored in association with the neighbor relationship information 1b. Downstairs resident suffering from floor noise can make it easier for upstairs neighbor to install the app by providing the gift to upstairs neighbor with kind messages. Moreover, the neighbor relationship can be automatically set. In such a way, personal information such as address stored in QR code cannot be identified with the naked eye, so it is advantageous to protect personal information.

As another example of inter-floor neighbor pairing, after installing the app, when signing up for a communication service, the address of the residence (apartment name, residence #) may be provided by the user, and then based on the database 10 in which user ID, Apartment name, Residence # are stored in FIG. 5, an inter-floor neighbor relationship can be established. Alternatively, if the user logs in with another social networking service (hereinafter referred to as “SNS”) account after installing the app, the address information stored in that account may be used to establish the inter-floor neighbor relationship. To prevent a situation where the wrong residence address is entered and thus the inter-floor neighbor relationship is established incorrectly, a notification window may pop up periodically to allow the app user to check whether the residence address is correct.

As another example of installing the app, in cooperation with the apartment's management office, residents may be instructed to install the inter-floor neighbor communication app. All apartment residents can install the app to set up a neighbor relationship between floors. Thereafter, by providing a platform for communication among residents through understanding and consideration, it is possible to reduce noise complaints among neighbor residents and prevent disputes in advance to build apartment houses without noise disputes.

In a case where users voluntarily download the app from the app store and install it, when any user in a neighbor relationship with another user signs up for the inter-floor neighbor communication platform, the server will automatically establish the inter-floor neighbor relationship based on the residence information of those users and notify the users that they are paired up as the inter-floor neighbor relationship.

When the pairing is completed between the inter-floor neighbors, they are ready to select a inter-floor neighbor for communication. It is privacy-friendly because personal information such as phone numbers are not disclosed or exposed during this pairing process.

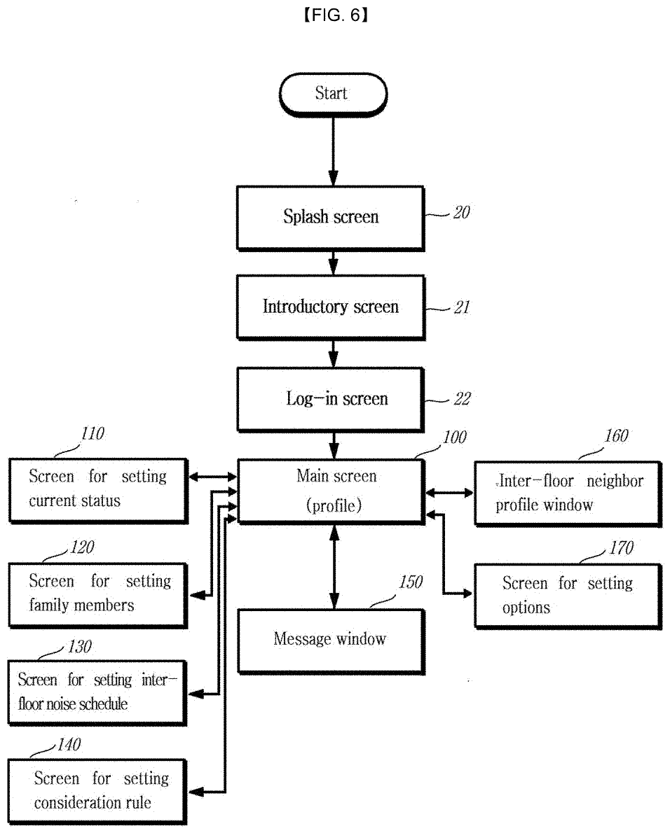

FIG. 6 shows the sequence of the inter-floor neighbor communication app according to one embodiment of the present invention. As soon as the app is run, the splash screen 20 appears. An app name and logo on the representative color of the app can be displayed in the splash screen 20. Then, it is switched to a guide screen 21. For example, Introductory phrase such as “SoyTalk is designed to resolve floor noise issue through caring and understanding!” may be displayed. Then, it proceeds to the login screen 22. For the first login, registration for membership is required. Log-in is a procedure to verify that you are a legitimate user. Typically, you can authenticate with a user ID and password. Alternatively, it may be certified based on other SNS login information.

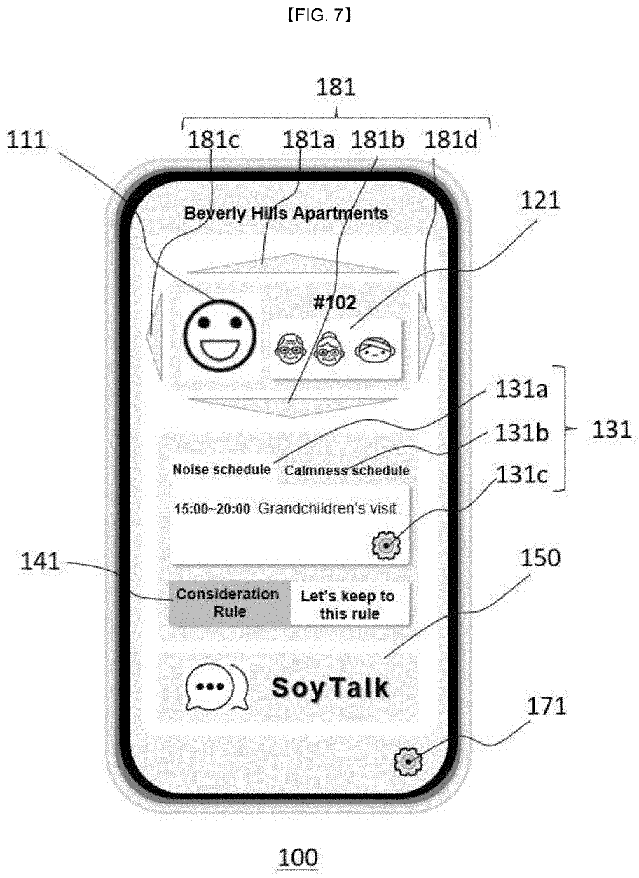

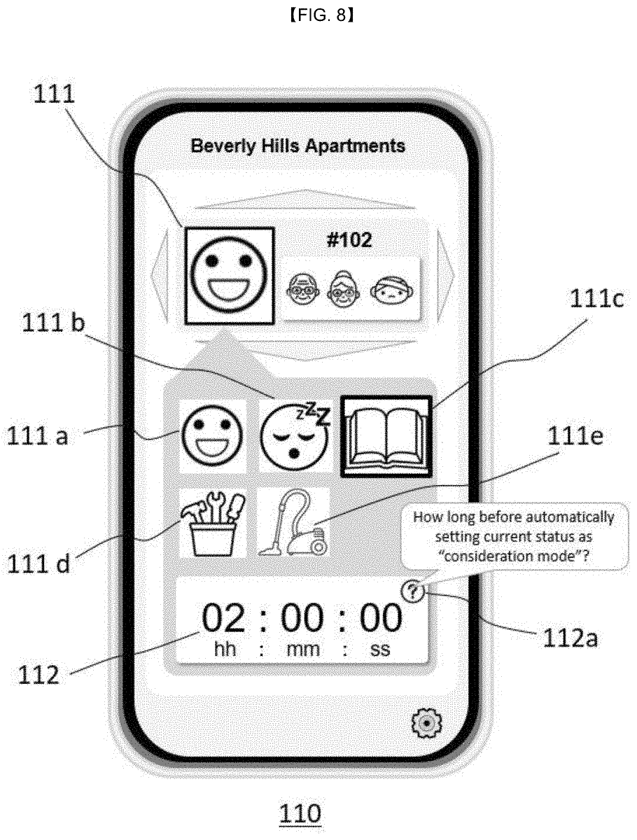

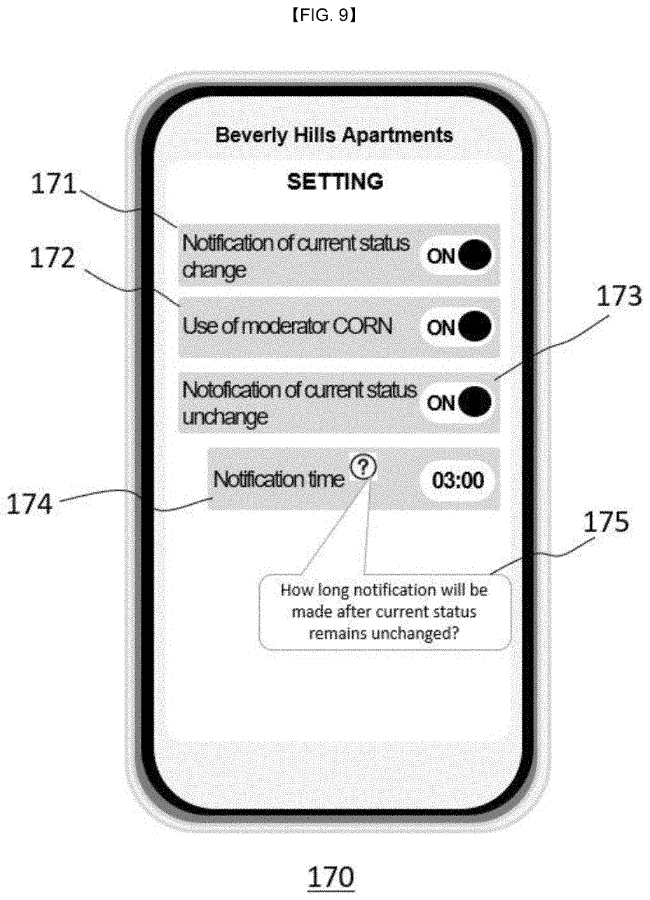

The main screen 100 illustrated in FIG. 7 is displayed. On the main screen, a window showing information related to various living spaces may be arranged. For example, there is a window for the user's current status 111 regarding noise between floors, the profile 121 of the household in which the user resides, the schedule for floor noise 131, and the consideration rule 141 to agree with the neighbors between floors. The neighbor information such as the profile 121, the schedule for floor noise 131 and consideration rule 141 may be input in advance or intermittently rather than in real time. In addition, a message window 150 for exchanging a conversation with a neighbor between floors, various setting icons 171 for setting the environment, and a selection button 181 for selecting a neighbor between floors may be disposed. If an inter-floor neighbor with whom you want to communicate is selected, it may be switched to the corresponding profile window 160. If such a window 160 is selected, it may switched to a setting screen for changing the corresponding information, and then return to the main screen 100 again.

When the icon 111 indicating the current status regarding the noise between floors is selected on the main screen 100, the current status setting screen of FIG. 8 may be displayed. One's current status is an indicator of the acceptable level of noise between floors. For example, the currently set icon 111a denotes a situation where a resident of Residence #102 does not feel bothered by the noise between floors (“consideration mode”). Exemplary situations are that there may be no one in residence #102, the noise between floors may not be felt, or the noise between floors may not be felt to the extent that it is uncomfortable. Neighbors living in residence #202 can identify the status of residence #102 and live without concern about the noise between floors, so the current status of residence #102 gives consideration to residence #202. Privacy information such as the absence of resident at residence #102 through the consideration mode information is not transmitted to resident at #202 as it is. Thus, privacy that may affect safety can be protected.

Similarly, the tool icon 111d and the cleaning icon 111e denotes situations where the current floor noise is not uncomfortable because the noise generated by his/her own is high enough to be not bothered by the noise caused by his/her neighbor.

On the other hand, the sleeping icon 111b and the reading icon 111c indicate that the resident at #102 is sensitive to the floor noise (“request mode for calmness”). In other words, the inter-floor upstairs neighbor, i.e., residents at #202 and #302 will recognize that they need to be careful not to generate the noise.

The more icons 111a, 111b, 111c, 111d, and 111e, in greater detail can the current status regarding the floor noise be explained and it will be easier to get understanding from neighbors. If a resident user does not want to inform his/her current status too detail, he/she may be able to configure only representative icons indicating the consideration mode and the request mode for calmness, respectively.

A method of setting the current status according to another embodiment will be described. Based on information collected from cameras, microphones, proximity sensors, and various Internet of Things (IoT) sensors installed on the lower floor and/or noise-related information between floors, it is possible to automatically determine the consideration mode and the request mode for calmness.

The current status 111, i.e., the icon 111b of the request mode for calmness, may be maintained until the app user changes it. Alternatively, it may be automatically switched back to a default mode, i.e., the icon 111a of the consideration mode when the time input through the timer window 112 lapses. When the information mark 112a at upper righter corner of the timer window is selected, explanation of the timer function will be provided. Whether to use the timer function may be determined depends on whether the timer is set.

The timer function has the advantage of being able to solve the problem resulted from the app user who once selected the “request mode for calmness” forgetting to change the current status. In addition, the timer function also helps to encourage mutual consideration so that upstairs neighbor can live without stress about having generated the floor noise.

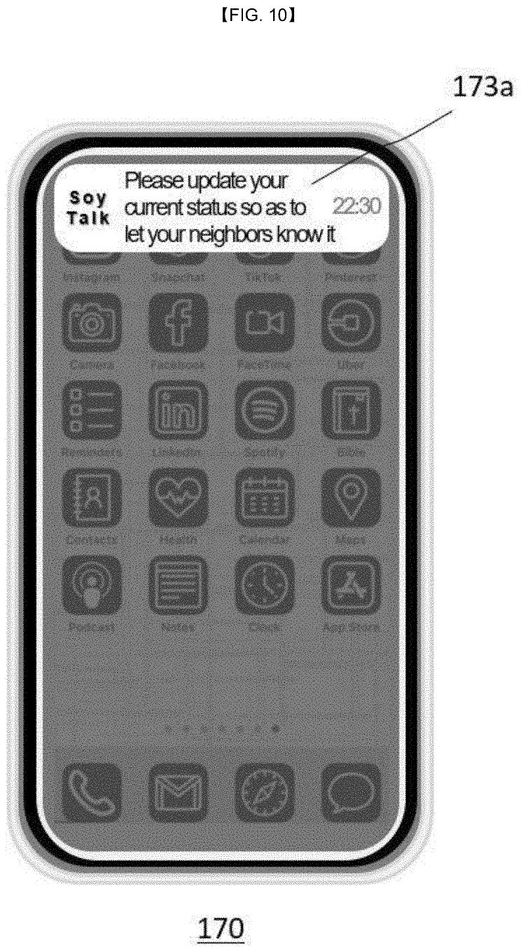

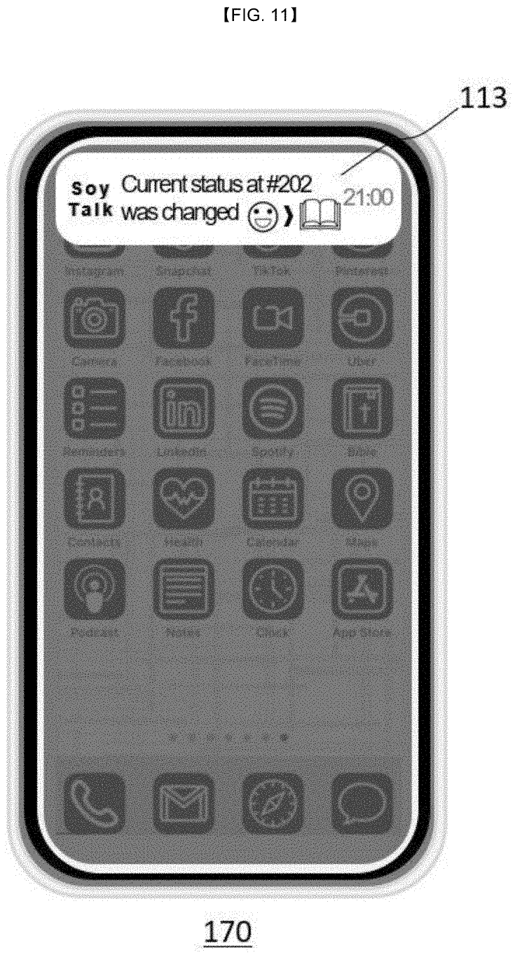

In order to solve the problem resulted from not changing the current status in real time, as shown in the option setting screen of FIG. 9, the ‘current status neglect notification’ setting 173 may be changed. When this setting is turned on, if there is no change in the current status for a certain period of time which was set in the ‘notification time’ setting 174, the notification 173a may be made to the terminal device of the app user as shown in FIG. 10. The app user who has received the notification 173a may update his/her current status 111. If the current status may be updated as accurately as possible in real time, a upstairs neighbor can be active at a convenient time. When the downstairs neighbor wants to remain quiet, it is possible not to cause floor noise to the downstairs neighbor as much as consideration which a downstairs resident provided to the upstairs neighbor.

In particular, when the current status 111 changes, the notification 113 will be provided to the terminal device of the user. For example, let's say that a notification that the current status in the residence #202 was changed from the consideration modes 111a, 111d, or 111e to the request mode for calmness 111b or 111c was made to the residence #302. This means that the noise caused in the residence #302 interfered with learning and reading in the residence #202. Or, it means the request for refraining from causing the noise because a resident user at #202 is about to reading or studying. If there was a running or thumping in the residence #302 which is upstairs before a resident at #302 received a notification, the resident at #302 will be able to act with care by recognizing immediately that he/she caused floor noise enough to make his/her downstairs neighbor feel uncomfortable or uneasy. Conventionally, it was difficult for residents upstairs to know if their action had caused an unpleasant noise to their downstairs neighbor. The more such action by upstairs neighbor is repeated, the more complaints from downstairs neighbor are piled up. When patience is exhausted, the downstairs neighbor would exercise verbal abuse or violence, thereby severely aggravating their neighbor relationship. On the other hand, since a upstairs resident can receive immediate feedback on his/her own action according to the present invention, he/she could be prevented from repeating the actions unintentionally.

On the other hand, since the perception of floor noise is subjective, the downstairs residents react sensitively to even the slightest daily noise and frequently change to the request mode for calmness 111b, 111c, 111e. Here, the communication device according to the present invention may give appropriate attention to the downstairs residents through big data analysis or artificial intelligence. For example, AI or big data analysis can help remind users of the fact that he/she is too much demanding if there are more changes to the request mode for calmness than average number of other neighbors. In particular, it is advantageous to enable residents to look back on themselves by comparing statistics with their inter-floor neighbors with other similar households. CORN as the in-app moderator may output a precautionary warning saying that ‘If you live in an apartment, daily noise can happen everywhere during day-to-day activities. If you are patient and considerate, your neighbors will appreciate and take care of you vice versa’.

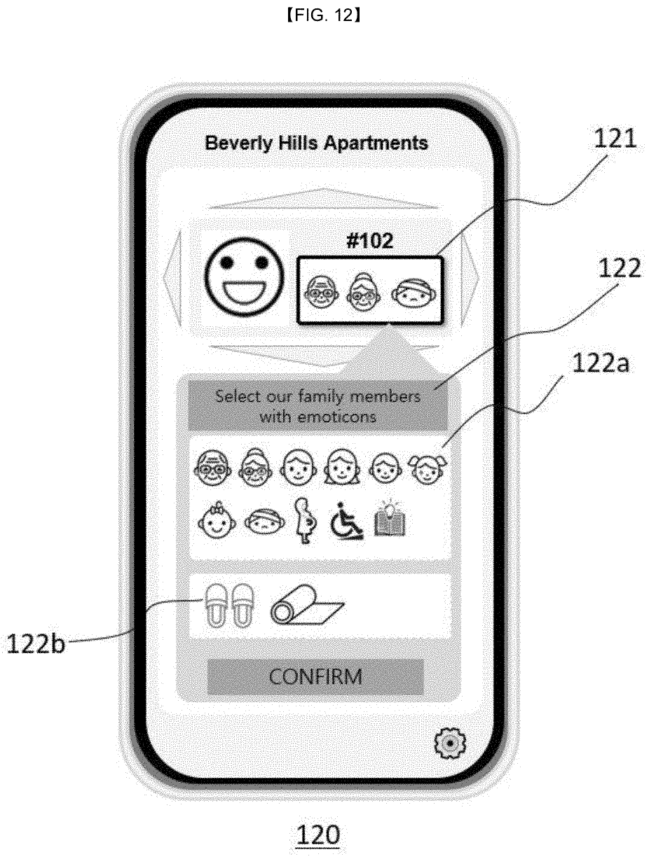

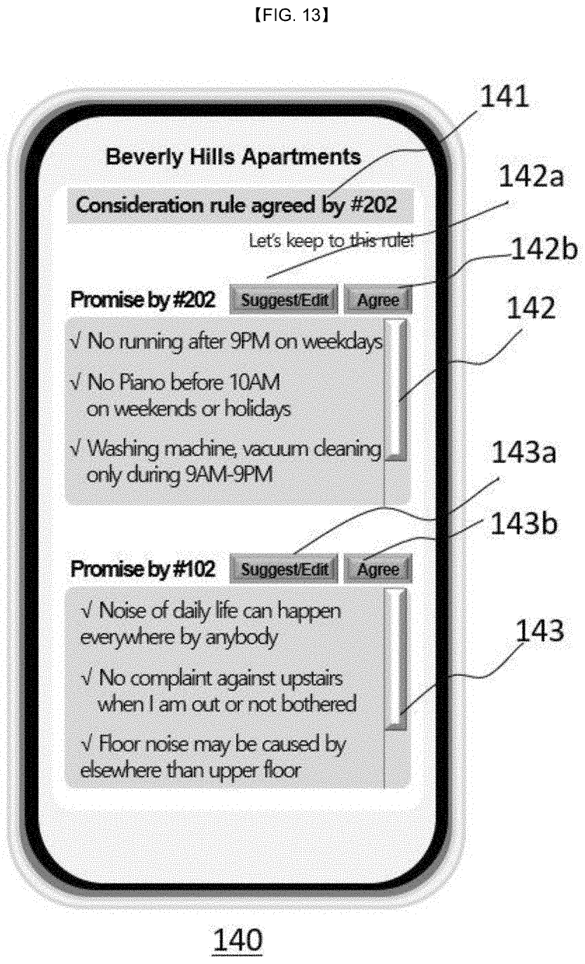

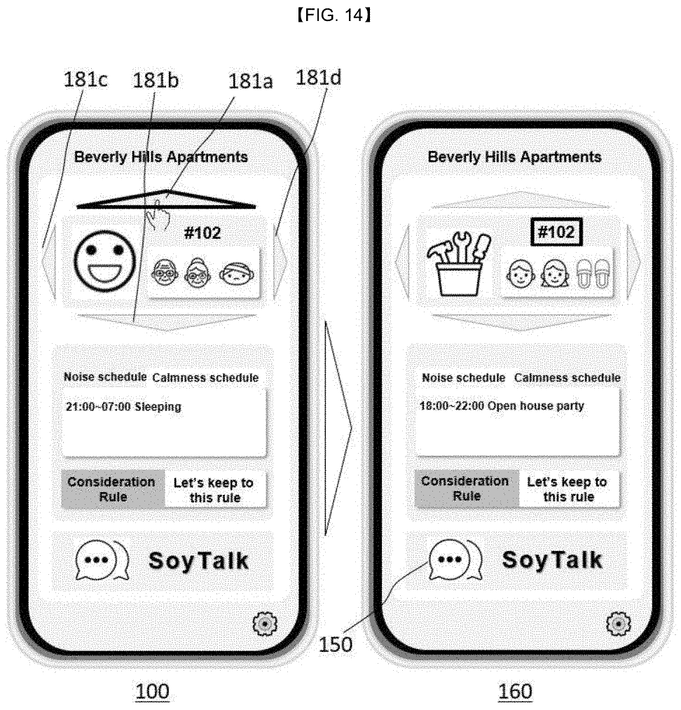

In addition, the record of setting and changing the current status 111 by the app user can be made in a log and used as evidence or reference in case of a future dispute or as big data for service improvement. For example, the frequency, timeline and total time when the current status was set as the request mode for calmness may be stored in a log of a resident user downstairs. Similarly, Feedback to the request mode may be stored in a log of a resident user upstairs. When the profile window 121 of the selected household is selected on the main screen 100, the setting screen 120 of FIG. 12 will be displayed. The profile 122 may be composed of a family member 122a and a floor noise prevention article 122b in residence #102. Based on the family member data, neighbor household will recognize whether there is a class of person sensitive to the floor noise or likely to cause the floor noise among their neighbors. The noise prevention articles 122b make it possible for others to know that their neighbor is also making efforts to reduce the floor noise. For example, a resident at #202 can know if there are patients, pregnant women, a test taker, or the elderly who are sensitive to the floor noise at lower floors of #102, so upstairs resident may easily understand their neighbors and take precautions to contain the floor noise. Similarly, residents at #102 can know that upstairs neighbor is using slippers and floor mats to reduce the noise, so they will be grateful for upstairs neighbor and will be more considerate and patient even when there is floor noise from upstairs. Also, the resident at #102 may be more willing to tolerate the noise from upstairs because they know in advance that children live upstairs who tend to run across floor.

In addition to people, companion animals (not shown) that may cause the noise may be displayed on the family member 122a for their neighbor's information. Since the noise source can be accurately identified when the companion animals generated the noise, it is possible to avoid complaints against incorrect source of the noise. Although not shown in the drawings, a type of floor noise source existing in a corresponding household may be further displayed in the neighbor profile window.

Examples of noise sources include home appliances such as washing machine, massage chair, clothes stylus, and treadmill, which are mainly identified as vibration and noise sources. Based on the information on the type of noise source, it will be more likely to know in which neighbor residence the floor noise was generated and thus directly communicate with the neighbor residence in a method to be described later.

According to the inter-floor communication method according to an embodiment of the present invention, as shown in FIG. 7, the floor noise schedule 131a and the calmness schedule 131b may be set in the schedule window 131. The floor noise schedule 131a may indicate a date and time when the floor noise likely to arise. For example, suppose that at residence #102, grandchildren will visit their grandparents' house to have dinner in the afternoon on April 5. ‘15:00-20:00 grandchildren visit’ may be displayed on the floor noise schedule on April 5 at #102. Neighbors can anticipate the floor noise at #102 in advance and advantageously they will be more tolerant of the floor noise at that time.

Similarly, the calmness schedule may indicate a time when a resident wants to live quietly without stress from the floor noise. For example, suppose a resident at #102 returns home from a night shift and has to sleep until noon the next day, or there is a student who has an important test on April 10th. The calmness schedule for residence #102 may indicate ‘Sleep from 05:00 to 12:00’ or ‘April 7-9, 19:00 to 24:00 Study for exam’. Alternatively, for privacy reason, only the time period can be set without specific reasons such as sleeping or studying for an exam, or it can be labeled just as ‘need to be quiet’. Accordingly, upstairs neighbor, i.e., residents at #202, may be more careful to contain the noise during that time period. In this way, there forms a virtuous cycle effect in which the residents at #102 who is thankful for calmness for that time period to upstairs neighbor at #202 and thus vice versa they will be more willing to understand the floor noise from upstairs #202 at other times. The floor noise schedule and the calmness schedule can be set by pressing the schedule setting button 131c.

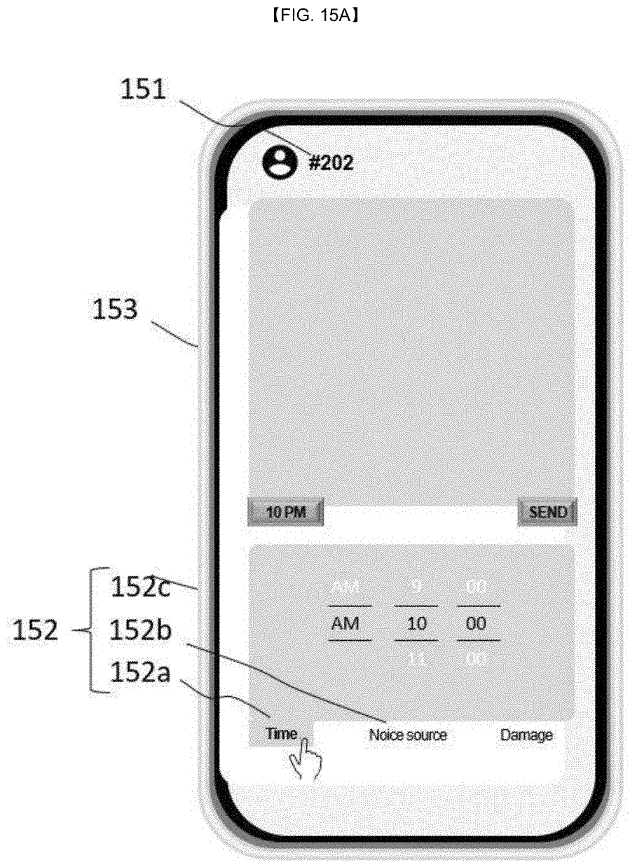

FIG. 13 shows a screen for setting consideration rules 141 in the inter-floor communication app according to an embodiment of the present invention. Each resident tend to have special circumstances, such as living patterns, sensitivity or acceptance of floor noise, types of floor noise with which the resident can't stand, and a time period during which the resident can't stand. In the old traditional society where communication between neighbors was active and frequent, disputes over noise would occur less frequently than now because they understood the special circumstances of their neighbors. On the other hand, in modern society, neighbors who live multi-unit residences do not even know each other, so the understanding for the floor noise is insufficient.

Inventors of the present invention believe that the consideration rule 141 agreed between the upper and lower floors can alleviate this problem. The consideration rule 141 may play a role of minimum requirements with that one of neighbors between floors hope the other to always comply in view of one's own life pattern or inclination. Take, for example, the resident at #102 who goes to bed before 10 PM and wants to keep sleeping quietly until late in the morning on weekends. As long as that resident's request or requirement is followed by upstairs neighbor, that resident may be more tolerant of the floor noise from upstairs while they are awake or at other times.

Now, it will be described the process as to how the consideration rule is set. A resident at #102 writes the rules that its neighbor at #202 wants to follow in the rule window 142, and press ‘Suggest/Edit’ button 142a. A upstairs neighbor at #202 may confirm this and agree as it is by pressing ‘Agree’ button 142b. On contrary, the upstairs neighbor at #202 may modify the rules by pressing ‘Suggest/Edit’ button 142a. In this case, when the resident at #102 presses ‘Agree’ button 142b, the agreement is reached and then the consideration rule will be set and shared between the inter-floor neighbors.

Similarly, a resident at #202 may first propose the rules through the downstairs rule window 142 to ask its neighbor at #102 to follow, and then the rules 141 can be made as soon as the neighbor at #102 agrees to the rules.

Since the inter-floor neighbors agreed upon the rules based on each other's needs, they will try to keep to these rules as much as possible. Accordingly, complaints involving the floor noise will be reduced. In addition, since they can feel considerate of each other through this process, noise disputes between floors can be significantly reduced. Meanwhile, if one break the agreed rules, cause the floor noise and cause damage to its neighbors, then the responsibility will be clear and so it will be easier to resolve disputes.

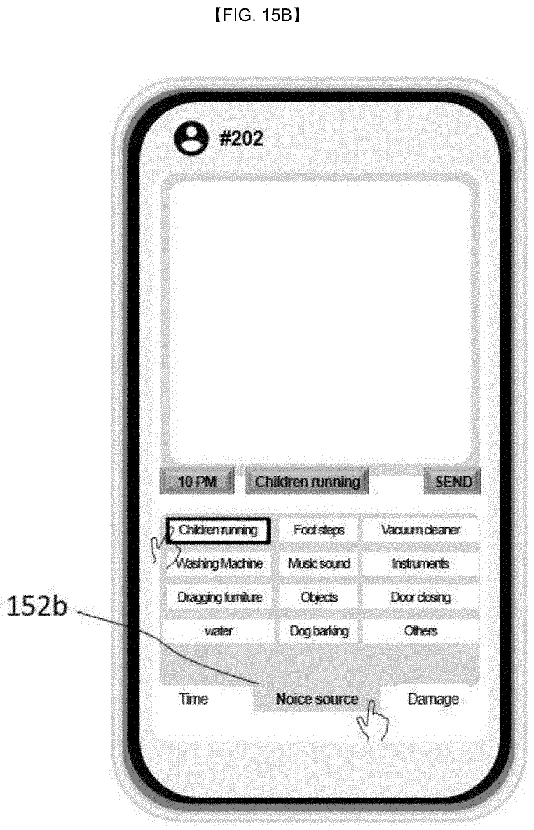

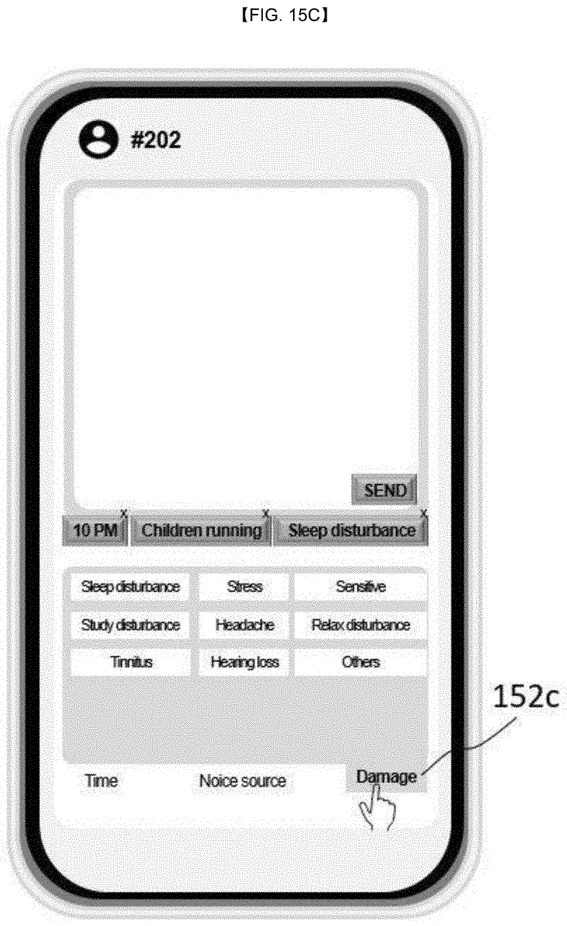

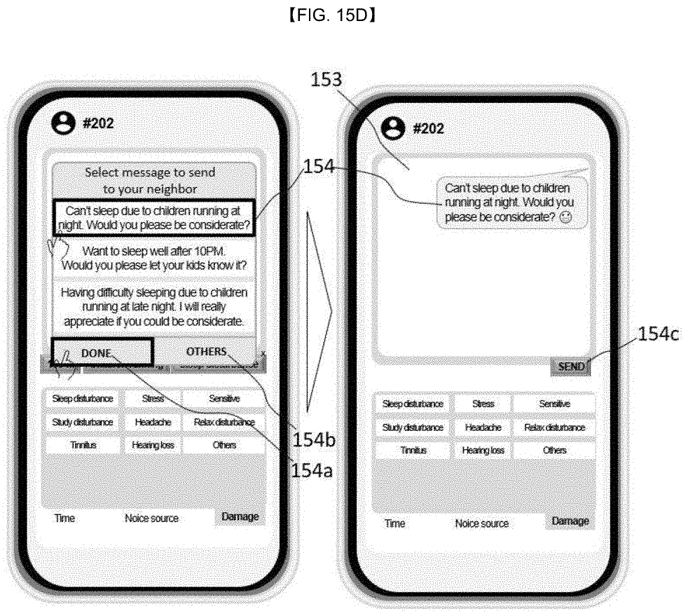

According to an embodiment of the present invention, a method for communicating with a plurality of inter-floor neighbors regarding the floor noise is provided. First, how to select a neighbor to communicate with will be described with reference to FIG. 14 by taking an app user residing at #102 as an example. Pressing the up arrow button 181a enables to select the upstairs residence at #202. Likewise, the left arrow button 181c for the next door residence at #101, the right arrow button 181d for the residence at #103. When the inter-floor neighbor is selected, the current status 111, the profile 121, the schedules 131, the consideration rule 141, and the chatting message window 150 of the selected residence are displayed accordingly. When the up arrow button 181a is pressed once more, the residence at #302 can be selected instead of #202. As described above, in a situation where the noise between floors is not necessarily transmitted from the upper floor directly, the function that enables to select a specific neighbor among a plurality of surrounding neighbors to communicate with will be useful. For example, when psychological stress is inflicted due to dog barking, the inflicted resident can identify its neighbor who has a dog through the inter-floor neighbor profile information, so it is possible to prevent unnecessary misunderstandings and conflicts with neighbors who did not cause that inconvenience. Referring to FIGS. 14 and 15, an embodiment generating a message in which a resident at #102 kindly requests its upstairs neighbor at #202 to reduce inconveniences such as floor noise will be described.

FIGS. 15A to 15D shows a process of generating a message that informs its neighbor of the damage suffered from the floor noise and requests to contain the noise. First, a resident at #102 selects the neighbor 151 to communicate with and clicks on the SoyTalk window 150. The time 152a when the floor noise occurred, the noise source 152b, and the damage 152c suffered by the resident at #102 are displayed below the message input window 153. A message to be delivered to its upstairs neighbor is composed of only the three types of information. Accordingly, only the three facts necessary without any other unnecessary statements which may be offensive, provocative or insulting to its neighbor is delivered. With the message, the upstairs resident can readily recognize occurrence of the floor noise on its floor and suffering of the downstairs neighbor, and thus will be cautious to prevent additional floor noise. As shown in FIG. 15A, after the ‘time’ button 152a is selected, morning or afternoon may be selected and a specific time at which the floor noise occurred can be selected. As shown in FIG. 15B, upon the ‘noise source’ button 152b being selected, various noise sources are displayed and one of them can be selected. Lastly, as shown in FIG. 15C, upon the ‘damage’ button 152c being selected, various types of damage are listed and one of them can be selected. As such, after selecting ‘10 o'clock’ and ‘PM’ in the ‘time’, ‘children running’ in the ‘noise source’, and ‘sleep disturbance’ in the damage, and pressing the ‘SEND’ button, several expressions 154 using words selected above may be recommended for user selection as shown in FIG. 15D. The expression is made to fit the context based on the selected keyword. If one expression, i.e., “Can't sleep due to children running at night. Would you please be considerate?” is selected and the ‘DONE’ button 154a is pressed, the selected expression is transmitted through the server to a smart phone of the upstairs neighbor at #202 and displayed in the dialog window 153.

A rule-based or an artificial intelligence (“AI”)-based expression recommendation algorithm may be used. The AI-based algorithm can use a model trained based on a log of existing communication between inter-floor neighbors, i.e., residences at #102 and 202 and current status. In addition, by pre-processing noise dispute resolution case data to create an input data set to be used for training, the AI learning model can recommend expressions optimized for specific situations.

The words or phrases presented in each category of the time 152a, the noise source 152b, and the damage 152c are exemplary, and may be adaptively presented by actively adjusting the phrase optimized for the user through AI learning. In addition, the time, noise source, and category of damage may also be changed, added, or appropriately adjusted. As an alternative embodiment, if an user inputs a key word or phrase of a message to be delivered without designating a category, an appropriate expression or sentence may be recommended based on the input key word or phrase. A plurality of sentences may be recommended for user selection. The recommendation may be sequentially presented until a recommended sentence is accepted by the user.

In this manner, instead of a message written arbitrarily in relation to the inter-floor noise through the communication window 153a, this invention restricts the message to be written and delivered in refined and polite manner while its meaning is substantially maintained. In other words, since expressions or tones that are offensive or insulting are not delivered, the inter-floor neighbor does not feel bad and bad feelings will be avoided compared to when talking face-to-face or exchanging arbitrarily written messages.

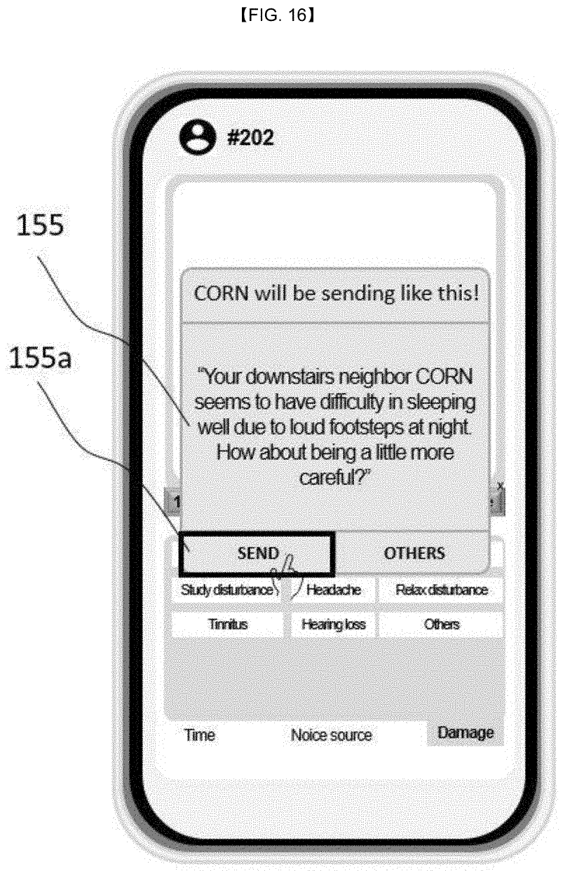

As another embodiment of presenting the recommended message, as shown in FIG. 16, the message 155 may be presented as if a third-party moderator speaks on behalf. If the ‘SEND’ button 155a is pressed, the message is delivered to the app user at #202. As for the floor noise disputes, conversations or messages are made through a third-party moderator instead of being made directly between neighbors, making it easier for the neighbors to control emotions and prevent escalation into disputes or violent crimes.

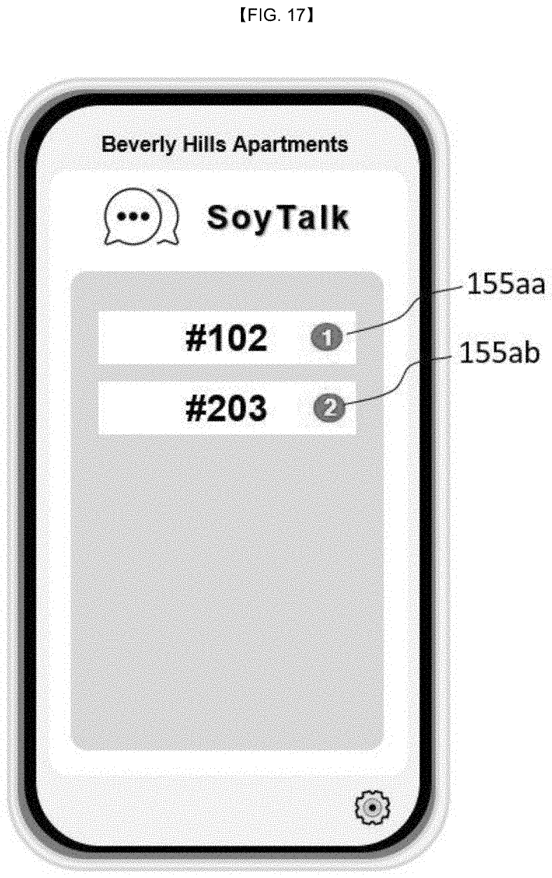

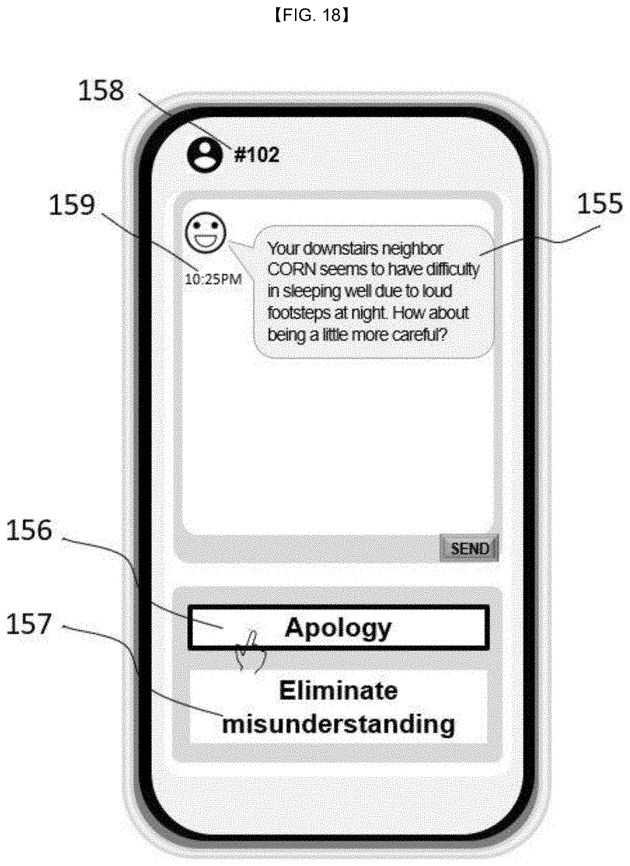

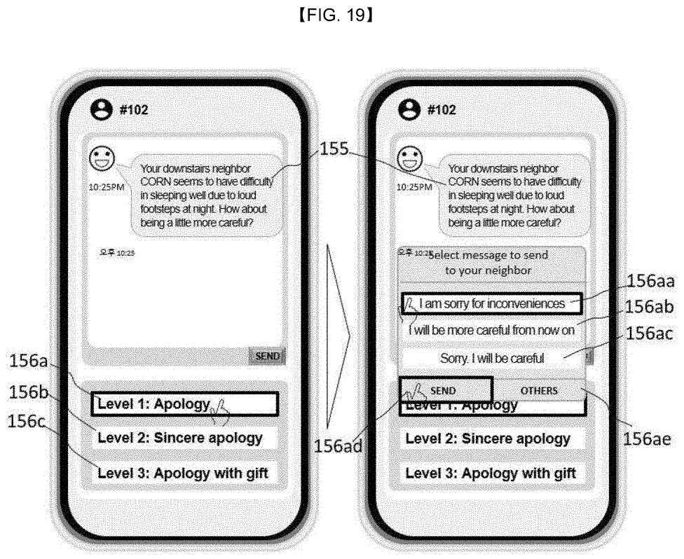

As shown in FIG. 17, the number of messages received from one's neighbor may be displayed next to the residence number of that neighbor as shown in FIG. 17. Therefore, it is possible for an app user to easily recognize un-read messages and provide immediate feedback to the received message. In FIG. 18, when the resident at #202 opens the received message, the resident can recognize who sent it, what the message is about, and when it was sent.

As shown in FIG. 19, upon receiving the message from neighbor, i.e., downstairs, the upstairs resident at #202 is provided with a function to immediately feedback to the neighbor who sent the message to request to contain the floor noise. When the upstairs resident thinks that it is #202 which has caused floor noise, he/she may press the ‘Apology’ button 156, and then the level of apology appears for the user to select.

If the first level of ‘Apology’ (156a) is selected, expressions such as ‘I am sorry for inconveniences’ (156aa), ‘I will be more careful from now on’(156ab), ‘Sorry. I will be careful’ (156ac) are displayed for the user to select. When the ‘OTHERS’ button 156ae is pressed, another expressions for ‘Apology’ may be presented. When the ‘SEND’ button 156ad is pressed, a message 158 of an apology is displayed on the app of the lower floor, i.e., #102, as shown in FIG. 22.

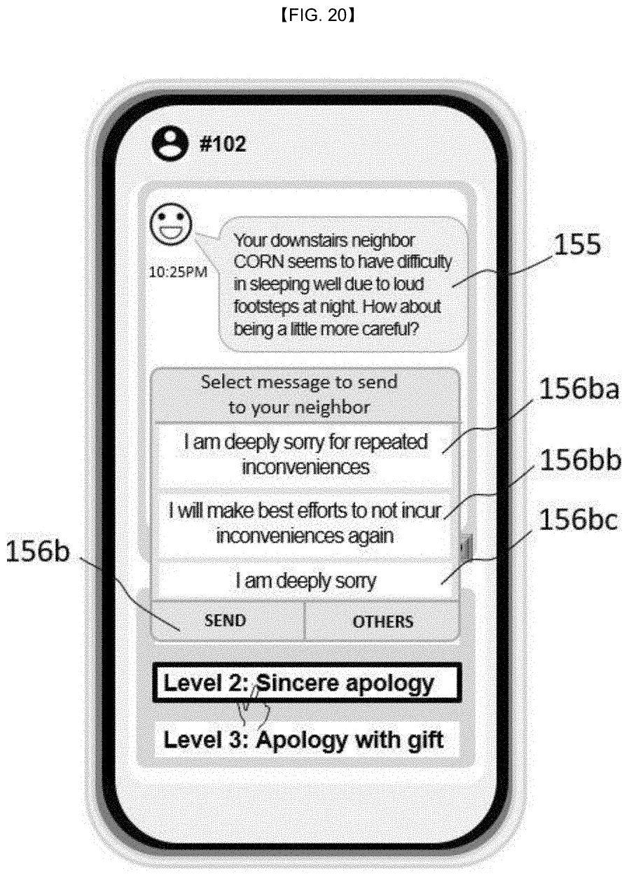

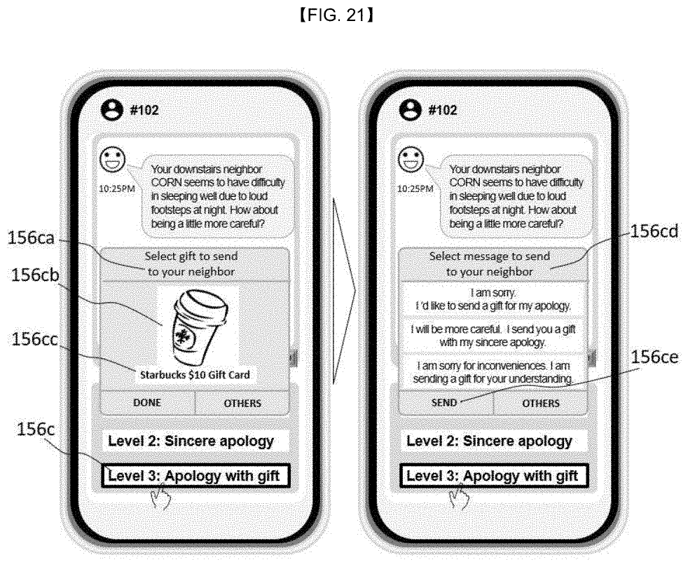

Referring to FIG. 20, if the second level of ‘Sincere apology’ (156b) is pressed, expressions such as ‘I am deeply sorry for the repeated inconveniences’(156ba) ‘I will make best efforts to not incur inconveniences again’ (156bb) ‘I am deeply sorry’ (156bc) are displayed for the user to select.

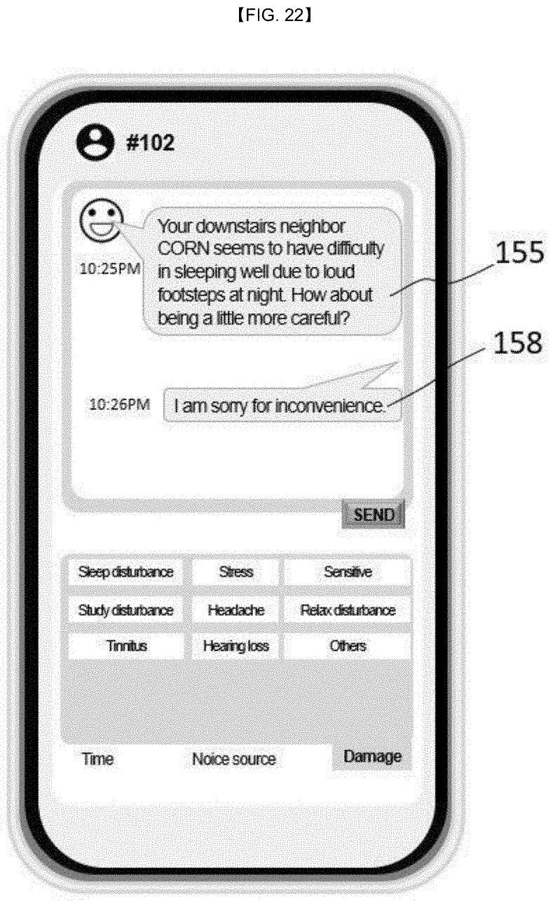

Referring to FIG. 21, if the third level ‘Apology with gift’ 156c is selected, a window 156ca for selecting a desired gift appears and recommended gifts 156cb are displayed. After selecting the desired gift, the user may click on the ‘DONE’ button (156cc) to complete the selection. Afterwards, a window (156cd) for selecting a message to be transmitted with the selected gift appears and recommended messages are also displayed. Upon selecting the message and clicking on the ‘SEND’ button 156ce, a feedback message along with the gift is delivered to the downstairs neighbor at #102. A separate page for purchasing gift or anti-floor noise products may be provided in the app according to an embodiment of the present invention. On that page, an user can pay for the gift selected in the process of sending an apology message, or the user can select and purchase other products which prevent the floor noise, i.e., slippers, cushioning mat on the floor. Alternatively, the page can be configured to link to other online shopping app or website. A mailing address for delivery of purchased gift or noise preventing products can be automatically populated based on the location information of the inter-floor neighbor or the residence address of the inter-floor neighbor. Depending on the situation in which the gift is selected, the message may be configured to automatically recommended for the user to select. For example, if the user chooses to give as a gift during ‘Apology’, the message such as ‘My children are still young, so I am concerned that they may make a lot of noises between floors. Should there be any inconvenience, let us know it and we will try our best too.” For another example, if the user selects a its neighbor to communicate with and chooses to give a gift, ‘Hello. We recently moved in on the lower floor. We hope that we can live without noise and psychological stress through mutual understanding and consideration.’ or ‘Hello. We are a new upstairs neighbor. We may make floor noise inadvertently sometimes, but if you could understand it, we will appreciate it and try to contain the floor noise as much as possible.”

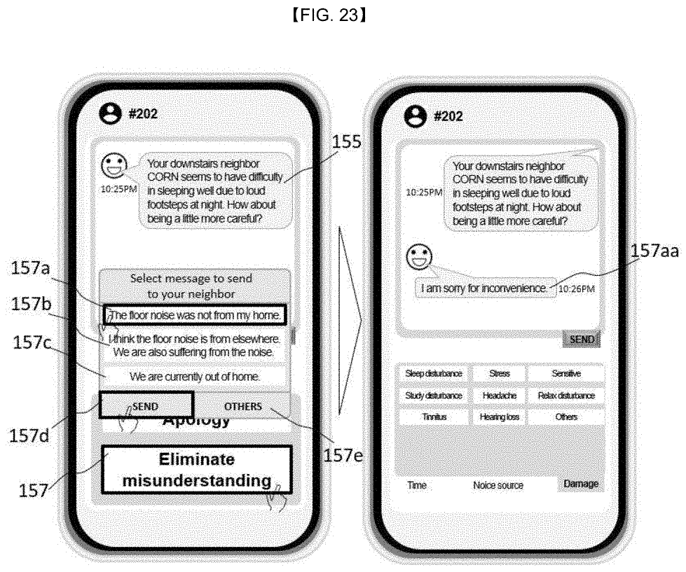

Referring to FIG. 23, an embodiment of upstairs neighbor's feedback in response to downstairs resident's request for calmness will be described. Let's say that the upstairs neighbor received the message from downstairs that says the floor noise caused him/her to be nervous or suffer from psychological stress, but in fact the resident at #202 has not generated the floor noise. In this situation, the recipient of the message may elect to click on the ‘Eliminate misunderstanding’ button 157, which results in several recommended sentences 157a, 157b, and 157c on the display of a smart phone. If the sentence of ‘The floor noise was not from my home’ 157a is selected and the ‘SEND’ button 157d is clicked on, the sentence 157a will be transmitted to the app of the user resident at #102 and the message 157aa will be displayed on the smart phone.

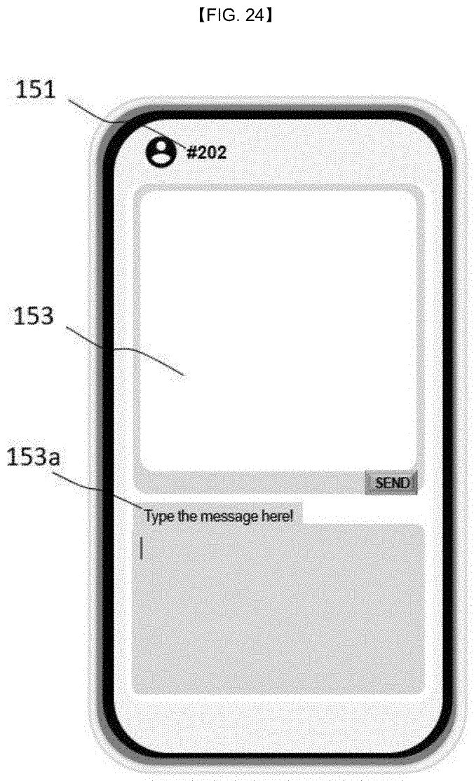

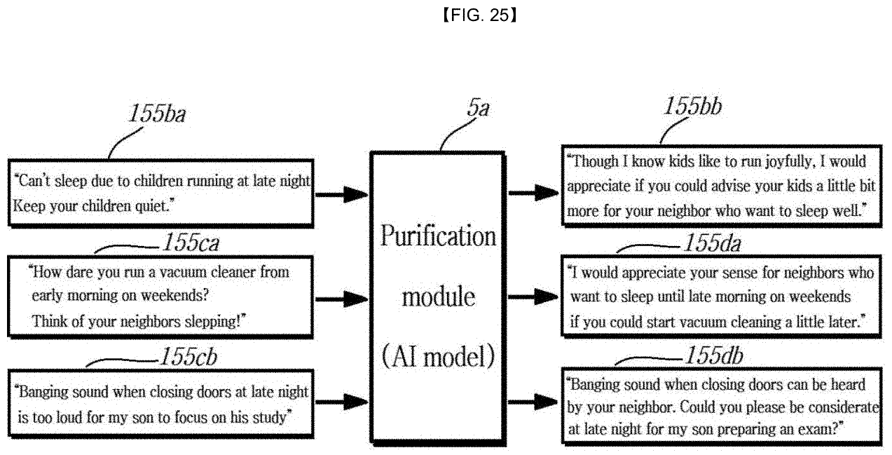

Referring to FIG. 24, an embodiment of generating a message requesting to contain the floor noise in a refined and polite manner will be described by taking as an example of inter-floor neighbors at #102 and 202. If the chatting message window 150 is clicked on, a chatting window 153 and chatting box 153a appear. In the chatting box 153a, the app user resident at #202 can directly type the message. Then, the input message is analyzed for its meaning and processed to transform into another expression which is kind, refined and/or polite while the meaning being substantially maintained. FIG. 25 shows an example in which a suggestion message to be delivered through the inter-floor neighbor communication app according to an embodiment of the present invention is purified or transformed by the purification module 5a of the AI agent 5. When the resident at #102 types the first expression 155ba, 155ca, 155da regarding the floor noise transmitted from upstairs at #202, the purification module 5a uses a rule-based or AI-based model to transform the first expression into the second expression which is more friendly and euphemistic. Each of the second expressions 155bb, 155cb, and 155db may be converted and output. In this way, the resident at #202 who received the second expression through a terminal device such as a smart phone, tablet PC can know situation and requests of downstairs neighbor in a way that is not offensive or provocative. In addition, by converting into the second expression from a perspective of a mediator, i.e., in a manner that neighbor parties do not speak back and forth face to face, it is possible to prevent the feelings between the neighbor parties to the floor noise dispute from being escalated. In the same way, the neighbor resident at #202 can type a reply to the request message from the resident at #102 in the chatting box 153a. Even if the reply from the resident at #202 is an unpolite expression, the purification module 5a converts it into a more polite expression and nuisance before transmitting the modified expression.

In the above embodiments, a method for generating a suggestion message and a feedback message using a text input method has been described, but the protection scope of the present invention is not limited thereto and obviously includes an embodiment of communication using a voice input method using a voice recognition function.

In addition, the communication method of the present invention may be implemented by linking the mobile app and the voice recognition AI speaker. For example, if a terminal device user selects the voice input icon to input the message of FIG. 24, the purified expression is output or displayed on the AI speaker and/or mobile app of the the user's neighbor.

The common feature throughout the specification of the present invention is that the chat window 150 function and the current status 111 function are used for communication between inter-floor neighbors. While a notification of current status change provides real-time feedback from downstairs residents as to whether the sound from upstairs really annoys the downstairs neighbor, the chat window function can directly express feeling or request in various ways regarding inconveniences and dissatisfaction caused by the inter-floor noise. In the present invention, in order to encourage thoughtful and friendly communication, the exchange of direct messages through the chat window as described above would be preferred under certain restrictions or limitations.

The various techniques described herein can be controlled by hardware or software, or a combination of hardware and software. All modifications and variations belonging to the true spirit and scope of the present invention are intended to be covered by the following claims.

What is claimed is:

1. A method of communicating among neighbors between floors, the method comprising:
storing, by a server, identification information of users of terminal devices for inter-floor neighbor relationship of the users;
receiving, from a first terminal device of a first user, the identification information of a second user who is a neighbor of the first user and with whom is selected or to be selected for communication by the first user;
communicatively connecting the first terminal device and a second terminal device of the second user based on the identification information; and
transmitting, by the server, current status information of the first user on inconvenience to the second terminal device of the second user,
wherein the inconvenience is to be caused by the second user.

2. The method of claim 1, further comprising:
storing, by the server, each neighbor information related to living spaces of at least one users of the terminal devices;
wherein the neighbor information is one that is stored either prior to or apart from communication instances between the users and the neighbor information is exclusively shared among the terminal devices of the users who are in the inter-floor neighbor relationship.

3. The method of claim 1, further comprising:
sending a notification to the second terminal device if the current status information is changed.

4. The method of claim 1,
wherein setting the inter-floor neighbor relationship is performed by the server based on the identification information of the users,
the identification information of a user is provided either upon input by his or her own or upon scanning an identification code by his or her neighbor user, and the identification code embeds the identification information in a manner that any personal information is not exposed.

5. The method of claim 4,
Wherein the identification code comprises at least one of an URL link for installation of an application software for the terminal device, an identification information of the user, and a residence information of the user.

6. The method of claim 4, wherein the setting the inter-floor neighbor relationship comprising:
obtaining residence information of users of the terminal devices; and
establishing, by the server, the neighbor relationship among the users in at least one of up, down, left, and right directions based on the residence information.

7. The method of claim 1,
wherein the current status information is selected from either (i) one or more of predetermined phrases or images indicating the current status or (ii) a second sentence or phrase converted from a first sentence or phrase input by the user of the first terminal device in a manner that the second sentence or phrase are more refined expression.

8. The method of claim 1,
wherein the current status information is a combination of at least two selected from a group comprising a cause of the inconvenience, a time period of the inconvenience occurrence and a type of suffering endured.

9. The method of claim 2,
wherein the current status information is determined based on either (i) at least one sensing data collected from a camera, a microphone, an objection detection sensor or various Internet of Things sensors, or (ii) the neighbor information.

10. The method of claim 2,
wherein the neighbor information comprises at least one of human, temporal, and object information related to the living space, and
the inconvenience is noise between floors,
the human information is a classification of residents,
the temporal information is a time period scheduled to generate noise between floors or a time period during which calmness is requested, and
the object information is an effort to reduce the noise or a product preventing the noise.

11. A method of communicating among neighbors between floors, the method comprising:
receiving, by a first terminal device of a first user, identification information of a second user who is a neighbor of the first user and with whom is selected or to be selected for communication by the first user;
establishing, by a server, a communication connection with the first terminal device and a second terminal device of the second user;
transmitting, by a server, a current status information of the first user on inconvenience to be caused by the second user and a neighbor information on living space of the first user to a second terminal device of the second user; and
when the current status information is changed, notifying the second user of the changed current status information.

12. The method of claim 11,
Wherein when the first user is a downstairs resident, the current status information is a first feedback information on the inconvenience such as noise between floors caused by the second user who is a upstairs resident, and
when the first user is a upstairs resident, the current status information is a second feedback information to the first feedback information.

13. The method of claim 11,
wherein the neighbor information comprises at least one of human, temporal, and object information related to the living space, and
the inconvenience is noise between floors,
the human information is a classification of residents,
the temporal information is a time period scheduled to generate noise between floors or a time period during which calmness is requested, and
the object information is an effort to reduce the noise or a product preventing the noise.

14. The method of claim 11,
wherein the current status information is selected from either (i) one or more of predetermined phrases or images indicating the current status or (ii) a second sentence or phrase converted from a first sentence or phrase input by the user of the first terminal device in a manner that the second sentence or phrase are more refined expression.

15. The method of claim 11,
wherein the current status information is a combination of at least two selected from a group comprising the inconvenience, a time period of the inconvenience occurrence and a type of suffering endured.

16. The method of claim 11,
wherein the current status information is determined based on either (i) at least one sensing data collected from a camera, a microphone, an objection detection sensor or various IoT sensors, or (ii) the neighbor information.

17. An apparatus of communicating among neighbors between floors, comprising:
a communication interface connected in a network to terminal devices of resident users;
a memory storing instructions and identification information of the resident users executable by a processor; and
the processor, through the computer-executable command, configured to execute:
storing identification information of users of terminal devices for inter-floor neighbor relationship of the resident users;
receiving the identification information of a second resident user who is a neighbor of the first resident user and with whom is selected or to be selected for communication by the first resident user;
communicatively connecting the first and the second terminal devices based on the identification information; and
transmitting current status information of the first resident user on inconvenience to the second terminal device of the second resident user,
wherein the inconvenience is to be caused by the second resident user.

18. The apparatus of claim 17,
wherein when the first user is a downstairs resident, the current status information is a first feedback information on the inconvenience such as noise between floors caused by the second user who is a upstairs resident, and
when the first user is a upstairs resident, the current status information is a second feedback information to the first feedback information.

19. The apparatus of claim 17,
wherein the current status information is selected from either (i) one or more of predetermined phrases or images indicating the current status or (ii) a second sentence or phrase converted from a first sentence or phrase input by the user of the first terminal device in a manner that the second sentence or phrase are more refined expression.

20. The method of claim 17,
wherein the current status information is a combination of at least two selected from a group comprising the inconvenience, a time period of the inconvenience occurrence and a type of suffering endured.
